(19) United States
(12) Patent Application Publication
(10) Pub. No.: US 2014/0062611 A1
(43) Pub. Date: Mar. 6, 2014

(54) FILTERING DEVICE WITH SLOTTED GROUND STRUCTURE

(71) Applicant: NATIONAL TAIWAN UNIVERSITY, Taipei (TW)

(72) Inventors: TZONG-LIN WU, TAIPEI (TW); TSUI-WEI WENG, TAIPEI (TW); CHIH-YING HSIAO, TAIPEI (TW)

(73) Assignee: NATIONAL TAIWAN UNIVERSITY, TAIPEI (TW)

(21) Appl. No.: 13/714,704

(22) Filed: Dec. 14, 2012

(30) Foreign Application Priority Data
Aug. 31, 2012 (TW) 101131798

(51) Int. Cl. H04B 3/28; H01P 1/203

(52) U.S. Cl. CPC H01P 1/203
USPC 333/12; 333/204

(57) ABSTRACT

The present invention is related to a filtering device with slotted ground structure, comprising a first substrate, a second substrate and a pair of differential signal lines, in which a ground plane having slotted ground structure is provided between the first substrate and the second substrate. Each of the two differential signal lines is symmetric to each other and comprises a first line segment being horizontally provided on the top surface of the first substrate and a second line segment being horizontally provided on the bottom surface of the second substrate, respectively. The first line segment is connected to the second line segment through a vertically disposed conductive via. Thereby, a common-mode noise within a specific frequency band may be suppressed effectively, so as to avoid interference a differential-mode signal transmitted on the differential signal lines, due to the slotted ground structure etched on the ground plane.

### FIELD OF THE INVENTION

The present invention is related to a filtering device with slotted ground structure, particularly to a filtering device for the suppression of common-mode noise.

### BACKGROUND

As digital electronic products are advancing with each passing day, circuits of systems in the electronic products become more and more complex, and the problem of electromagnetic interference (EMI) or common-mode noise is then more serious, to be a significant barrier to normal operation of system.

To solve the problem of EMI, in the past, it is most common to use an electromagnetic material to achieve the suppression of EMI, in which the feature of high inductance of electromagnetic material is used to suppress the generation of EMI. In this case, however, only operation in low-frequency range is allowable, and the application in high-speed digital circuit is not easy due to bulky structure.

Alternatively, there is further provided with a multi-layered filtering device fabricated by low/high temperature co-fired ceramics technology (LTCC/HTCC) due to recent progress in fabrication process. In spite of acceptable effect on suppression of EMI, the cost of fabrication process of LTCC/HTCC is extremely high, and the filtering device is only capable of operating at low frequency range, for example, 750 MHz˜1 GHz.

In view of the above, how to provide a filtering device allowed for the effective suppression of EMI, simple fabrication process, and application in high/low-frequency range is the object to be achieved by the present invention desirably.

### SUMMARY OF THE INVENTION

It is one object of the present invention to provide a filtering device with slotted ground structure, in which a slotted ground structure is built in the filtering device, in such a way that the transmission characteristic of differential signal lines may be varied, so as to increase insertion loss within a specific frequency band to suppress the flow of common-mode noise through the differential signal lines, thus avoiding interference the differential-mode signal transmitted on the differential signal lines.

It is one object of the present invention to provide a filtering device with slotted ground structure, in which there are provided with at least two layers of substrates with a ground plane having slotted ground structure disposed therebetween. A pair of differential signal lines are horizontally provided on different surfaces of the substrates, respectively, and a line segment of one differential signal line is connected to that of the other via at least one conductive via passing through the substrates and the ground plane, in such a way that the differential signal lines are allowed to surround the slotted ground structure above and below it, so as to fabricate a filtering device of three-dimensional structure.

It is another object of the present invention to provide an equivalent circuit of a filtering device, in which the common-mode noise is guided to the ground potential or guided back to the original route, and then incapable of being transmitted continuously, so as to avoid the effect of common-mode noise on transmission of differential-mode signal.

To achieve above objects, the present invention provides a filtering device with slotted ground structure, used for suppressing common-mode noise generated when differential-mode signal is transmitted, comprising: a first substrate; a second substrate; a first ground plane, provided between the first substrate and the second substrate, comprising a first slotted ground structure; and a pair of differential signal lines, each of the two differential signal lines being provided symmetrically to each other, comprising a first line segment and a second line segment, respectively, the first line segment being horizontally provided on the top surface of the first substrate, the second line segment being horizontally provided on the bottom surface of the second substrate; wherein the first line segment is electrically connected to the second line segment through a vertically disposed first conductive via, the first conductive via passing through the first substrate, the first ground plane and the second substrate.

In one embodiment of the present invention, wherein a third substrate and a second ground plane are further provided between the first ground plane and the second substrate, the second ground plane comprising a second slotted ground structure, the first conductive via further passing through the third substrate and the second ground plane, in such as way that the second line segment is electrically connected to the first line segment through the first conductive via passing through the first substrate, the first ground plane, the third substrate, the second ground plane and the second substrate.

In one embodiment of the present invention, wherein an etching process is carried out on the first ground plane and the second ground plane to form the first slotted ground structure and the second slotted ground structure, in which the first slotted ground structure and the second slotted ground structure are presented as an identical etched shape or different etched shapes.

In one embodiment of the present invention, wherein a third substrate and a second ground plane are further provided under the second line segments of the pair of differential signal lines, the second ground plane comprising a second slotted ground structure.

In one embodiment of the present invention, wherein a third substrate, a second ground plane and a fourth substrate are further provided under the second line segments of the pair of differential signal lines, the second ground plane comprising a second slotted ground structure, furthermore, the pair of differential signal lines further comprising a third line segment horizontally provided on the bottom surface of the fourth substrate, the second line segment being electrically connected to the third line segment through a second conductive via passing through the third substrate, the second ground plane and the fourth substrate.

In one embodiment of the present invention, wherein the first slotted ground structure or the second slotted ground structure comprises a first section and a second section, a third section, a fourth section and a connection section, the connection section being extended perpendicularly to and across the pair of differential signal lines projectively, the first section and the second section being interconnected, on one side edge thereof; through the connection section, as well as being connected, on the other side edge thereof, to the third section and the fourth section, respectively, the third section and the fourth section facing each other, with a clearance therebetween, toward a center line between the pair of differential signal lines, wherein the first section and the second section are of the same size, while the third section and the fourth section are of the same size, the first section and the connection section being interconnected to form a first included angle, the second section and the connection section being interconnected to form a second included angle, the third section and the first section being interconnected to form a third included angle, the fourth section and the second section being interconnected to form a fourth included angle, the first included angle being equal to the second included angle, the third included angle being equal to the fourth included angle.

In one embodiment of the present invention, wherein the first slotted ground structure or the second slotted ground structure comprises a first section, a second section and a connection section, the connection section being extended perpendicularly to and across the pair of differential signal lines projectively, the first section and the second section being interconnected, on one side edge thereof, through the connection section, wherein the first section and the second section are of the same size, the first section and the connection section being interconnected to form a first included angle, the second section and the connection section being interconnected to form a second included angle, the first included angle and the second included angle being equal and presented as a non-right angle.

In one embodiment of the present invention, wherein the pair of first line segments, the pair of second line segments and/or the pair of third line segments of the pair of differential signal lines are provided with a pair of meandering parts symmetric to each other, respectively.

The present invention further provides a filtering device with slotted ground structure, used for suppressing common-mode noise generated when differential-mode signal is transmitted, comprising: a first substrate; a pair of differential signal lines, each of the two differential signal lines being provided symmetrically to each other, comprising a first line segment and a second line segment, respectively, the first line segment being horizontally provided on the top surface of the first substrate, the second line segment being horizontally provided on the bottom surface of the first substrate, the first line segment being electrically connected to the second line segment through a vertically disposed first conductive via, the first conductive via passing through the first substrate; a second substrate, provided above the first line segment; a third substrate, provided under the second line segment; a first ground plane, provided on the top surface of the second substrate, comprising a first slotted ground structure; and a second ground plane, provided on the bottom surface of the third substrate, comprising a second slotted ground structure.

In one embodiment of the present invention, wherein the first slotted ground structure or the second slotted ground structure comprises a first section and a second section, a third section, a fourth section and a connection section, the connection section being extended perpendicularly to and across the pair of differential signal lines projectively, the first section and the second section being interconnected, on one side edge thereof, through the connection section, as well as being connected, on the other side edge thereof, to the third section and the fourth section, respectively, the third section and the fourth section facing each other, with a clearance therebetween, toward a center line between the pair of differential signal lines, wherein the first section and the second section are of the same size, while the third section and the fourth section are of the same size, the first section and the connection section being interconnected to form a first included angle, the second section and the connection section being interconnected to form a second included angle, the third section and the first section being interconnected to form a third included angle, the fourth section and the second section being interconnected to form a fourth included angle, the first included angle being equal to the second included angle, the third included angle being equal to the fourth included angle.

In one embodiment of the present invention, wherein the first slotted ground structure or the second slotted ground structure comprises a first section, a second section and a connection section, the connection section being extended perpendicularly to and across the pair of differential signal lines projectively, the first section and the second section being interconnected, on one side edge thereof, through the connection section, wherein the first section and the second section are of the same size, the first section and the connection section being interconnected to form a first included angle, the second section and the connection section being interconnected to form a second included angle, the first included angle and the second included angle being equal and presented as a non-right angle.

In one embodiment of the present invention, wherein an etching process is carried out on the first ground plane and the second ground plane to form the first slotted ground structure and the second slotted ground structure, in which the first slotted ground structure and the second slotted ground structure are presented as an identical etched shape or different etched shapes.

In one embodiment of the present invention, wherein the pair of first line segments and/or the pair of second line segments of the pair of differential signal lines are provided with a pair of meandering parts symmetric to each other, respectively.

### BRIEF DESCRIPTION OF DRAWINGS

FIG. 1 is a three-dimensional structural view of a filtering device with slotted ground structure according to one preferred embodiment of the present invention.

FIG. 2 is a structural perspective top view of a filtering device with slotted ground structure according to one preferred embodiment of the present invention.

FIG. 3 is a structural perspective top view of a filtering device with slotted ground structure according to another embodiment of the present invention.

FIG. 4 is a structural perspective top view of a filtering device with slotted ground structure according to another embodiment of the present invention.

FIG. 5 is a structural perspective top view of a filtering device with slotted ground structure according to another embodiment of the present invention.

FIG. 6 is a structural perspective top view of a filtering device with slotted ground structure according to another embodiment of the present invention.

FIG. 7 is a structural perspective top view of a filtering device with slotted ground structure according to another embodiment of the present invention.

FIG. 8 is a structural perspective top view of a filtering device with slotted ground structure according to another embodiment of the present invention.

FIG. 9 is a structural perspective top view of a filtering device with slotted ground structure according to another embodiment of the present invention.

FIG. 10 is a three-dimensional structural view of a filtering device with slotted ground structure according to another embodiment of the present invention.

FIG. 11 a structural cross-sectional view a filtering device with slotted ground structure according to another embodiment of the present invention.

FIG. 12 is a structural perspective top view of a filtering device with slotted ground structure according to another embodiment of the present invention.

FIG. 13 is a structural perspective bottom view of a filtering device with slotted ground structure according to another embodiment of the present invention.

FIG. 14 is a structural perspective bottom view of a filtering device with slotted ground structure according to another embodiment of the present invention.

FIG. 15 is a structural cross-sectional view of a filtering device with slotted ground structure according to another embodiment of the present invention.

FIG. 16 is a structural cross-sectional view of a filtering device with slotted ground structure according to another embodiment of the present invention.

FIG. 17 is a structural cross-sectional view of a filtering device with slotted ground structure according to another embodiment of the present invention.

FIG. 18 is a structural cross-sectional view of a filtering device with slotted ground structure according to another embodiment of the present invention.

FIG. 19 is a structural perspective top view of a filtering device with slotted ground structure according to another embodiment of the present invention.

FIG. 20 is a diagram of circuit structure of an equivalent circuit of a filtering device according to one preferred embodiment of the present invention.

FIG. 21 is a diagram of circuit structure of an odd-mode equivalent circuit of the equivalent circuit illustrated in FIG. 20 of the present invention.

FIG. 22 is a diagram of circuit structure of an even-mode equivalent circuit of the equivalent circuit illustrated in FIG. 20 of the present invention.

FIG. 23 is an oscillogram obtained by differential-mode and common-mode full-wave simulation and measurement with respect to a filtering device with slotted ground structure of the present invention and equivalent circuit thereof.

FIG. 24 is an oscillogram illustrating the mode conversion with respect to a filtering device with slotted ground structure of the present invention.

FIG. 25 is an oscillogram illustrating output voltage of common-mode noise of a filtering device of the present invention.

FIG. 26 is an eye diagram of measurement on differential-mode signal of a reference device.

FIG. 27 is an eye diagram of measurement on differential-mode signal of a filtering device of the present invention.

### DETAILED DESCRIPTION

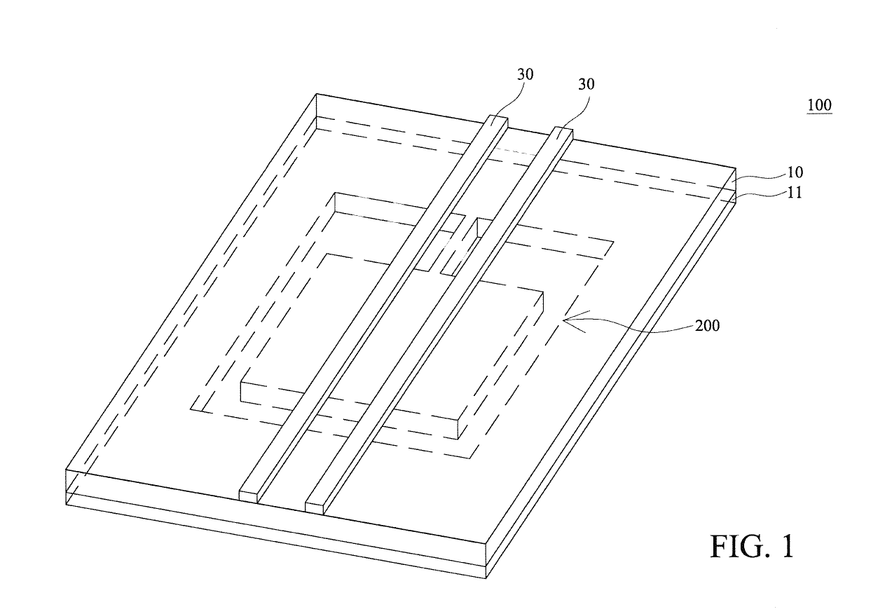

Referring to FIG. 1, there is shown a three-dimensional structural view of a filtering device with slotted ground structure according to one preferred embodiment of the present invention. As illustrated in the figure, the filtering device 100 comprises a substrate 10, a ground plane 11 and a pair of differential signal lines 30.

In this case, two differential signal lines 30 are provided on the top surface of the substrate 10 in parallel and symmetrically with respect to each other in the form of a micro strip line, an embedded micro strip line or a strip line. Moreover, an electromagnetic coupling is generated between the two signal lines 30.

The ground plane 11 is provided on the bottom surface of the substrate 10 and is a metal joining of the substrate 10. Furthermore, the ground plane 11 is etched to be different shapes so as to obtain a slotted ground structure 200. In practical differential transmission, one differential-mode signal and one common-mode noise are generated on the two differential signal lines 30, in which the former is a data signal or a control signal, while the latter is electromagnetic noise. The transmission characteristic of the differential signal lines 30 may be varied due to the provision of the slotted ground structure 200, in such a way that insertion loss is increased within a specific frequency band to suppress the flow of common-mode noise through the differential signal lines 30, thus avoiding interference the differential-mode signal transmitted on the differential signal lines 30.

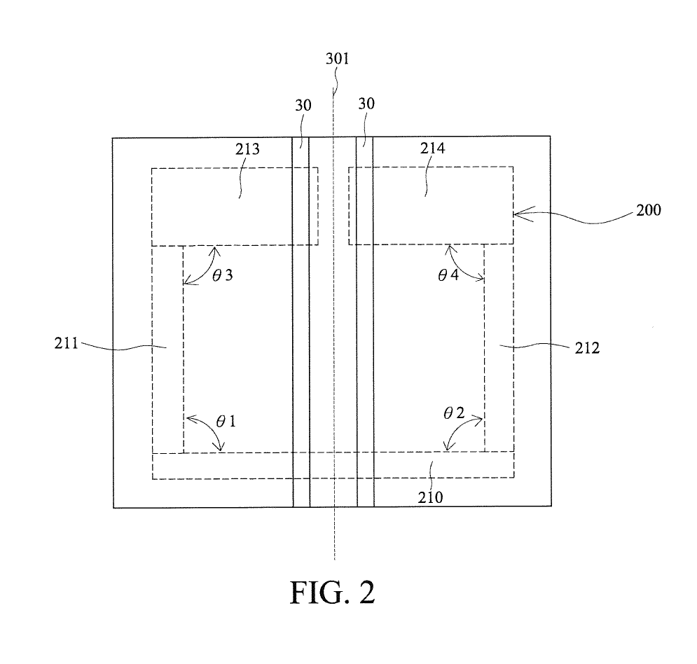

Referring to FIG. 2, there is shown a structural perspective top view of a filtering device with slotted ground structure according to one preferred embodiment of the present invention. As illustrated in the figure, the slotted ground structure 200 of the filtering device 100 comprises a connection section 210, a first section 211, a second section 212, a third section 213, and a fourth section 214.

In this case, the connection section 210 is extended perpendicularly to and across the pair of differential signal lines 30 thereunder projectively. The first section 211 and the second section 212 are interconnected, on one side edge (e.g. bottom edge) of each of them, through the connection section 210, while the first section 211 and the second section 212 are connected, on the other side edge (e.g. top edge) of each of them, with the third section 213 and the fourth section 214, respectively. Moreover, the third section 213 and the fourth section 214 are directed toward a center line 301 between the pair of differential signal lines 30 so as to face each other, and they are not interconnected with a clearance therebetween. Furthermore, in one embodiment of the present invention, parts of line segment of each of the pair of differential signal lines 30 may be projected onto the third section 213 and the fourth section 214, respectively.

The first section 211 and the second section 212 are of the same size, while the third section 213 and the fourth section 214 are of the same size. Furthermore, in one embodiment of the present invention, the width on each of right and left sides of the third section 213 and the fourth section 214 is greater than that on each of right and left sides of the connection section 210. Alternatively, in another embodiment of the present invention, the width on each of right and left sides of the third section 213 and the fourth section 214 may be also equal to that on each of right and left sides of the connection section 210.

A first included angle θ₁ is formed at the connection between the first section 211 and the connection section 210, a second included angle θ₂ is formed at the connection between the second section 212 and the connection section 210, a third included angle θ₃ is formed at the connection between the third section 213 and the first section 211, and a fourth included angle θ₄ is formed at the connection between the fourth section 214 and the second section 212. The first included angle θ₁ is equal to the second included angle θ₂, while the third included angle θ₃ is equal to the fourth θ₄ included angle. In this embodiment, preferably, the first included angle θ₁ the second included angle θ₂, the third included angle θ₃, and the fourth included angle θ₄ are designed as a right angle of 90 degrees, so as to form a C-shaped slotted ground structure 200.

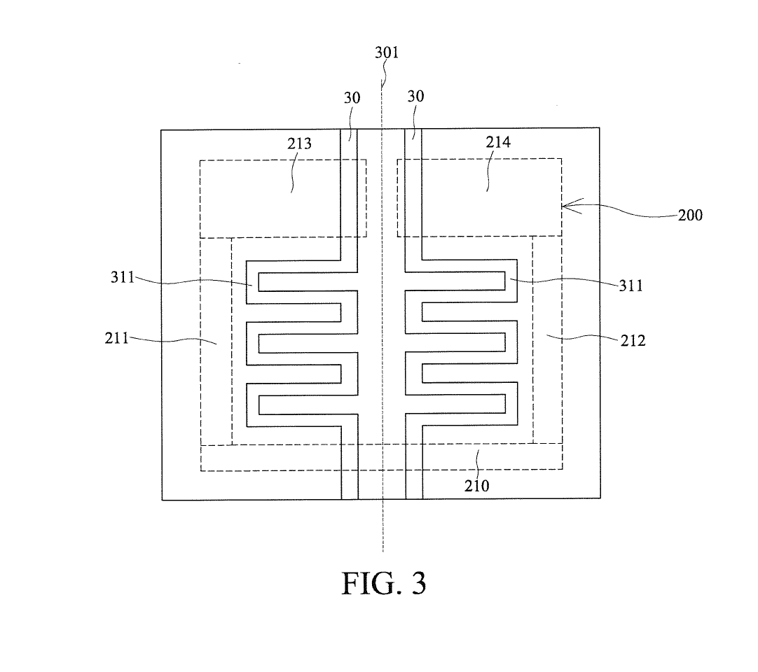

Furthermore, each of the two differential signal lines 30 are described in this present invention may be designed as a totally straight line segment, also referred to FIG. 2. Alternatively, as illustrated in FIG. 3, parts of line segment of each differential signal line 30 are designed with a meandering part 311, respectively. The two meandering parts 311 are symmetric to each other. The electromagnetic coupling region between the differential signal lines 30 and the slotted ground structure 200 may be increased due to the provision of the meandering parts 311, so as to further suppress common-mode noise within a wider frequency band. Although the differential signal line 30 in the form of a totally straight line segment is considered as a main explanatory element in each embodiment of the present invention, either the differential signal line 30 in the form of a totally straight line segment or the differential signal line 30 having meandering part 311 may be suitable for any one of embodiments of the present invention in practical design. Thus, depiction will not be repeated in the following embodiments.

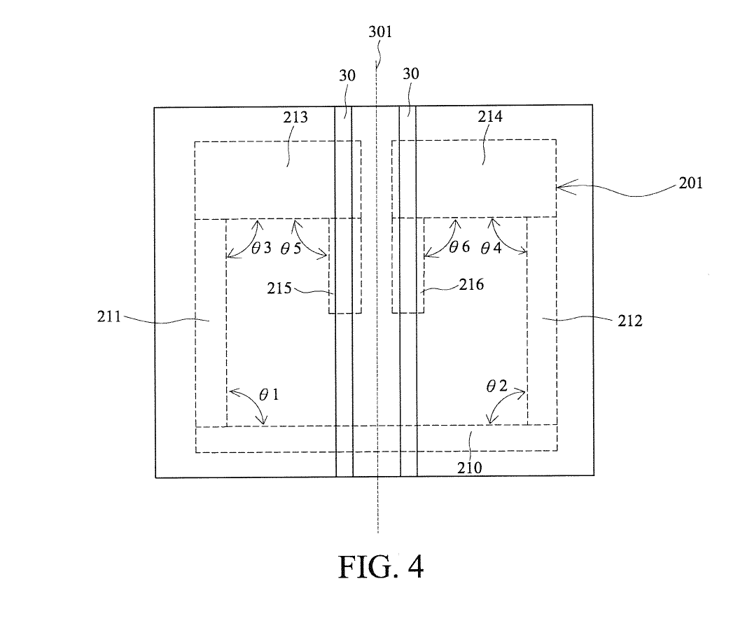

Referring to FIG. 4, there is shown a structural perspective top view of a filtering device with slotted ground structure according to another embodiment of the present invention. As illustrated in the figure, a slotted ground structure 201 of the present invention further comprises a fifth section 215 and a sixth section 216. The third section 213 is connected, on one side edge (e.g. left side edge) thereof, with the first section 211, while is connected, on the other side edge (e.g. right side edge) thereof, with the fifth section 215. The fourth section 214 is connected, on one side edge (e.g. right side edge) thereof, with the second section 212, while is connected, on the other side edge (e.g. left side edge) thereof, with the sixth section 216. Moreover, the fifth section 215 and the sixth section 216 are of the same size.

A fifth included angle θ₅ is formed at the connection between the third section 213 and the fifth section 215, while a sixth included angle θ₆ is formed at the connection between the fourth section 214 and the sixth 216. Moreover, the fifth included angle θ₅ and the sixth included angle θ₆ are similarly designed as a right angle of 90 degrees. Preferably, each of the fifth section 215 and the sixth section 216 may be provided under the corresponding differential signal line 30 projectively and parallel to the center line 301 of the pair of differential signal lines 30, respectively.

In one preferred embodiment of the present invention, the connection section 210 itself, as well as the first section 211, the third section 213 and/or the fifth section 215 and the second section 212, the fourth section 214 and/or the sixth section 216 are symmetrically provided on right and left sides of the center line 301, respectively, on the basis of the center line 301 between each of the pair of differential signal lines 301.

Furthermore, in the slotted ground structure 200/201 of the aforementioned embodiments of the present invention, a right angle of 90 degrees is designed at each connection between the sections. In practical design, however, a non-right angle may be also formed at the connection between the sections, as described in the following.

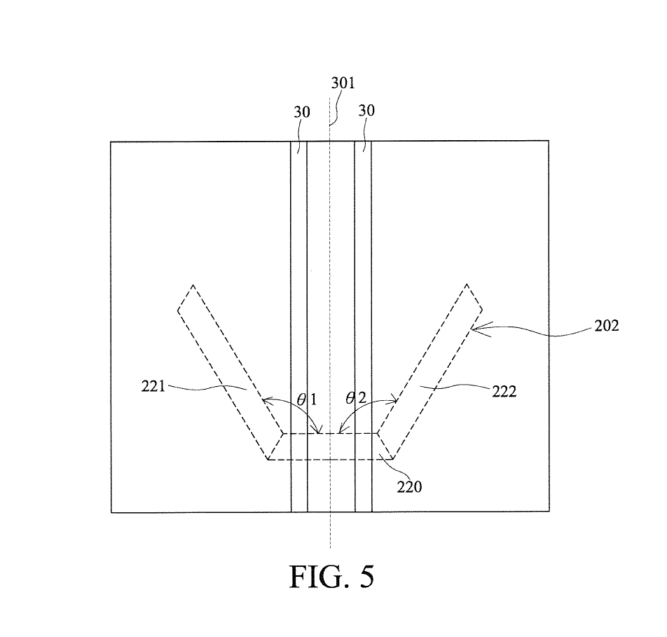

Subsequently, referring to FIG. 5, there is shown a structural perspective top view of a filtering device with slotted ground structure according to another embodiment of the present invention. As illustrated in the figure, the slotted ground structure 202 comprises a connection section 220, as well as a first section 221 and a second section 222. In this case, the connection section 220 is extended perpendicularly to and across the pair of differential signal lines 30 thereunder projectively. The first section 221 and the second section 222 are interconnected, on one side edge (e.g. bottom edge) of each of them, through the connection section 220. Moreover, the first section 221 and the second section 222 are of the same size. The first section 221 and the connection section 220 are interconnected to form a first included angle θ₁, while the second section 222 and the connection section 220 are interconnected to form a second included angle θ₂, the first included angle θ₁ and the second included angle θ₂ are equal and designed as a non-right angle of 120 degrees, for example, or other angles greater than 90 degrees.

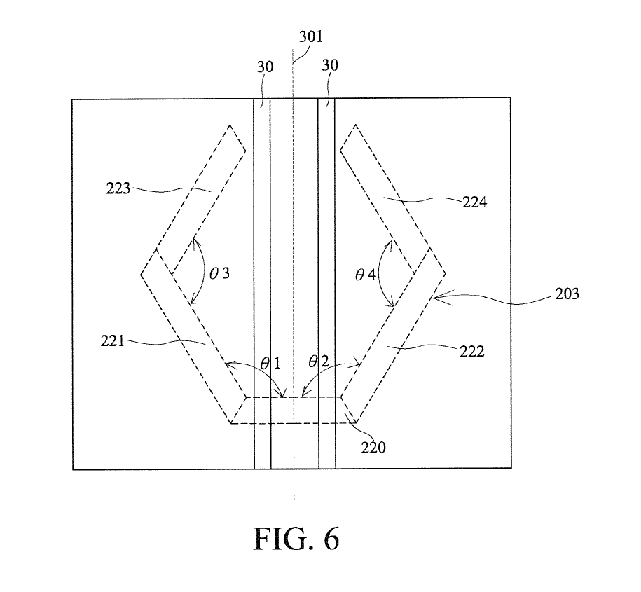

Referring to FIG. 6, there is shown a structural perspective top view of a filtering device with slotted ground structure according to another embodiment of the present invention. Compared with the embodiment in FIG. 5, the slotted ground structure 203 of the present invention further comprises a third section 223 and a fourth section 224. The first section 221 and the second section 222 are connected, on the other side edge (e.g. top edge) of each of them, with the third section 223 and the section 224, respectively. Moreover, the third section 223 and the fourth section 224 are of the same size. The third section 223 and the first section 221 are interconnected to form a third included angle θ₃, while the fourth section 224 and the second section 222 are interconnected to form a fourth included angle θ₄, the third included angle θ₃ and the fourth included angle θ₄ are equal and designed as a non-right angle of 120 degrees, for example, or other angles greater than 90°.

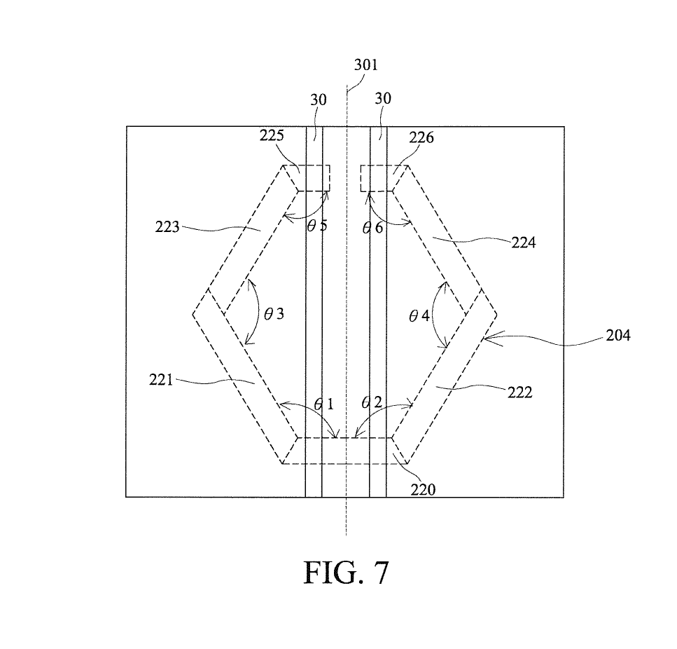

Referring to FIG. 7, there is shown a structural perspective top view of a filtering device with slotted ground structure according to another embodiment of the present invention. Compared with the embodiment in FIG. 6, the slotted ground structure 204 of the present invention further comprises a fifth section 225 and a sixth section 226. The third section 223 is connected, on one side edge (e.g. bottom edge) thereof, with the first section 221, while is connected, on the other side edge (e.g. top edge) thereof, with the fifth section 225. The fourth section 224 is connected, on one side edge (e.g. bottom edge) thereof, with the second section 222, while is connected, on the other side edge (e.g. top edge) thereof, with the sixth section 226. The fifth section 225 and the sixth section 226 are of the same size. The fifth section 225 and the third section 223 are interconnected to form a fifth included angle θ₅, while the sixth section 226 and the fourth section 224 are interconnected to form a sixth included angle θ₆ the fifth included angle θ₅ and the sixth included angle θ₆ are equal and designed as a non-right angle of 120 degrees, for example, or other angles greater than 90°. Preferably, the fifth section 225 and the sixth section 226 are directed toward the center line 301 between the pair of differential signal lines 30 so as to face each other, and they are not interconnected with a clearance therebetween. Furthermore, in one embodiment of the present invention, parts of line segment of each of the pair of differential signal lines 30 may be projected onto the fifth section 225 and the sixth section 226, respectively.

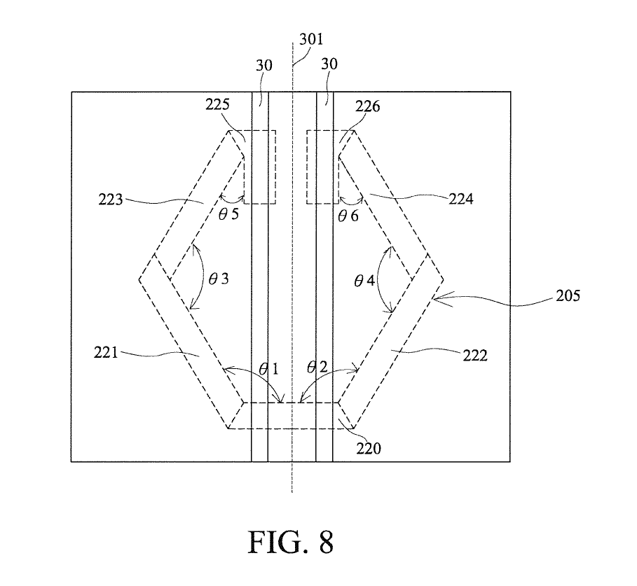

Alternatively, referring to FIG. 8, there is shown a structural perspective top view of a filtering device with slotted ground structure according to another embodiment of the present invention. In the slotted ground structure 204 of the embodiment illustrated in FIG. 7, each of the fifth included angle θ₅ formed at the connection between the fifth section 225 and the third section 223 as well as the sixth included angle θ₆ formed at the connection between the sixth section 226 and the fourth section 224 may be designed as an included angle being greater than 90 degrees. Correspondingly, in the slotted ground structure 205 of this embodiment, the fifth included angle θ₅ and the sixth included angle θ₆ may be also designed as an included angle smaller than 90 degrees, such as 30 degrees, instead. It is preferable, moreover, each of the fifth section 225 and the sixth section 226 may be provided under the corresponding differential signal line 30 projectively and parallel to the center line 301 of the pair of differential signal lines 30, respectively.

Furthermore, in one preferred embodiment of the present invention, the connection section 220 itself, as well as the first section 221, the third section 223 and/or the fifth section 225 and the second section 222, the fourth section 224 and/or the sixth section 226 are symmetrically provided on right and left sides of the center line 301, respectively, on the basis of the center line 301 between each of the pair of differential signal lines 30.

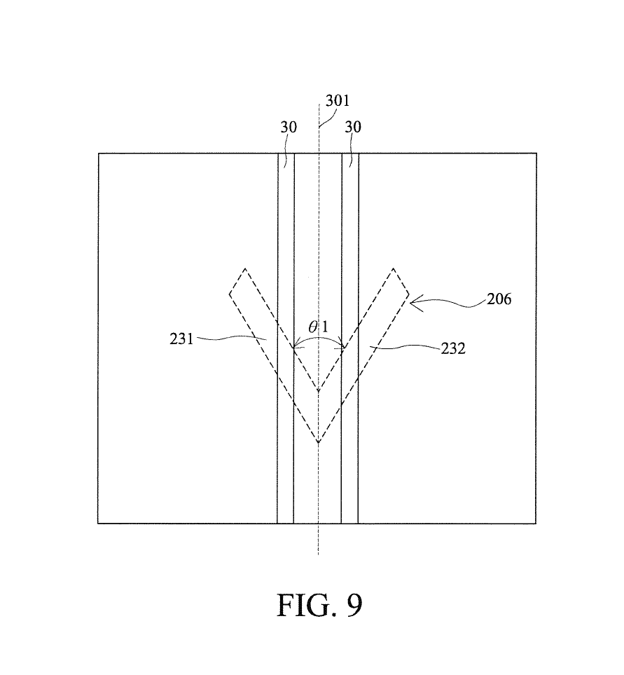

Referring to FIG. 9, there is shown a structural perspective top view of a filtering device with slotted ground structure according to another embodiment of the present invention. As illustrated in the figure, the slotted ground structure 206 of this embodiment comprises a first section 231 and a second section 232. One side edge of the first section 231 is connected with one side edge of the second section 232. The first section 231 and the second section 232 are of the same size. A first included angle θ₁ is formed at the connection between the first section 231 and the second section 232, and may be designed as a right angle or non-right angle (e.g. included angle greater than 90 degrees or included angle smaller than 90 degrees). Preferably, the first section 231 and the second section 232 described in this embodiment are symmetrically provided on right and left sides of the center line 301, respectively, on the basis of the center line 301 between each of the pair of differential signal lines 30.

In the slotted ground structure 200/201/202/203/204/205/206 of the present invention, the symmetric provided on right and left side of the center line 301, respectively, on the basis of the center line 301 between each of the pair of differential signal lines 30 is used as one preferred embodiment. In practical use, however, the slotted ground structure 200/201/202/203/204/205/206 may be asymmetrically provided on right and left sides of the center line 301, also allowed to create an acceptable suppression effect on common-mode noise transmitted on the differential signal lines 30. Therefore, the slotted ground structure 200/201/202/203/204/205/206 described in the present invention without being symmetrically provided on right and left sides of the center line 301 between the differential signal lines 30 still should be included in the scope of Claim of the present invention.

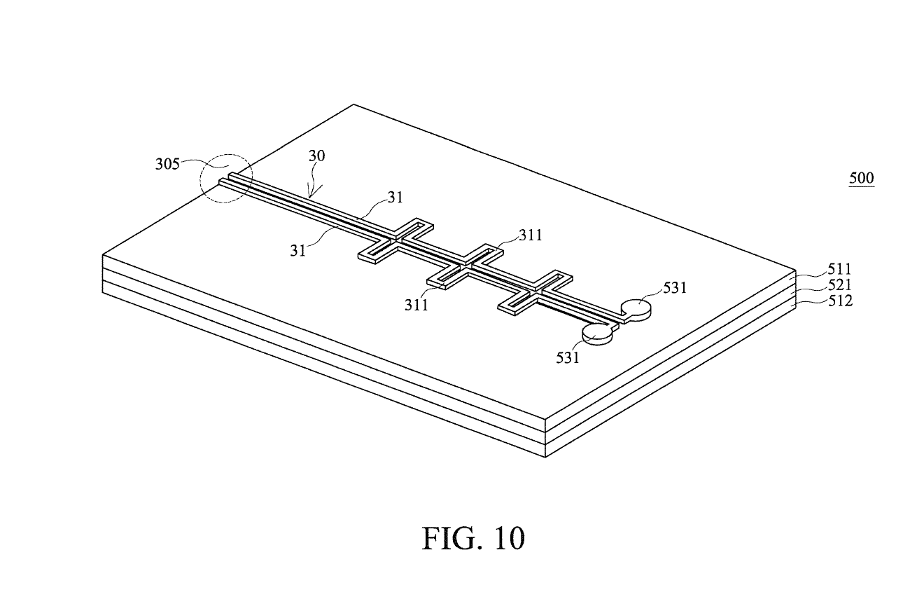

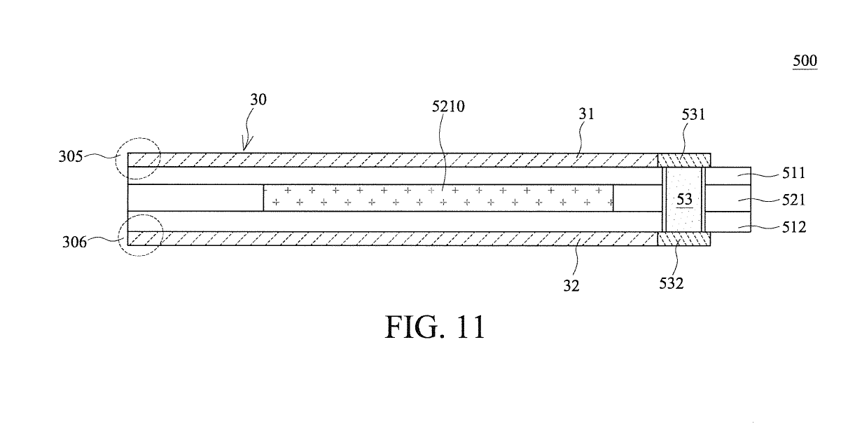

Referring to FIGS. 10, 11, 12 and 13, there are shown a three-dimensional structural view, structural cross-sectional view, structural perspective top view and structural perspective bottom view of a filtering device with slotted ground structure according to another embodiment of the present invention. As illustrated in the figures, the filtering device 500 comprises a pair of differential signal lines 30, a first substrate 511, a second substrate 512 and a first ground plane 521.

In this case, the first ground plane 521 is provided between the first substrate 511 and the second substrate 512, and the first ground plane 521 is etched so as to form a first slotted ground structure 5210. The first slotted ground structure 5210 is embodied as the slotted ground structure disclosed in any one of aforementioned embodiments. For instance, the slotted ground structure 203 in FIG. 6 is adopted as the first slotted ground structure 5210 of this embodiment.

Each of two differential signal lines 30, symmetrically provided to each other, may comprise a first line segment 31 and a second line segment 32, respectively. The first line segment 31 is horizontally provided on the top surface of the first substrate 511, while the second line segment 32 is horizontally provided on the bottom surface of the second substrate 512. In one embodiment of the present invention, any one of the two first line segments 31 and/or two second line segments 32 is a totally straight line segment. Alternatively, in another embodiment of the present invention, any one of the two first line segments 31 and/or two second line segments 32 is provided with a meandering part 311 and/or meandering part 321.

The filtering device 500 further comprises a first conductive via 53. The first conductive via 53 is vertically provided in the filtering device 500, and is allowed to pass through the first substrate 511, the first ground plane 521 and the second substrate 512. The first line segment 31 is connected to the first conductive via 53 via a first connection pad 531, while the second line segment 32 is connected to the first conductive via 53 via a second connection pad 532. Then, the first line segment 31 is thus allowed to electrically connect to the second line segment 32 through the vertically disposed first conductive via 53. Thus, when differential-mode signal is transmitted in the filtering device 500 in practice, differential-mode signal may be inputted from a signal input port 305, transmitted through the path consisting of the first line segment 31, the first conductive via 53 and the second line segment 32, and then outputted from a signal output port 306. In addition, the first conductive via 53 and the first ground plane 521 are electrically isolated from each other.

As such, the pair of differential signal lines 30 is designed to surround the slotted ground structure 5210 above and below it, respectively, by means of the horizontally disposed line segments 31, 32 and the vertically disposed conductive via 53, in such a way that a filtering device 500 of three-dimensional structure is formed.

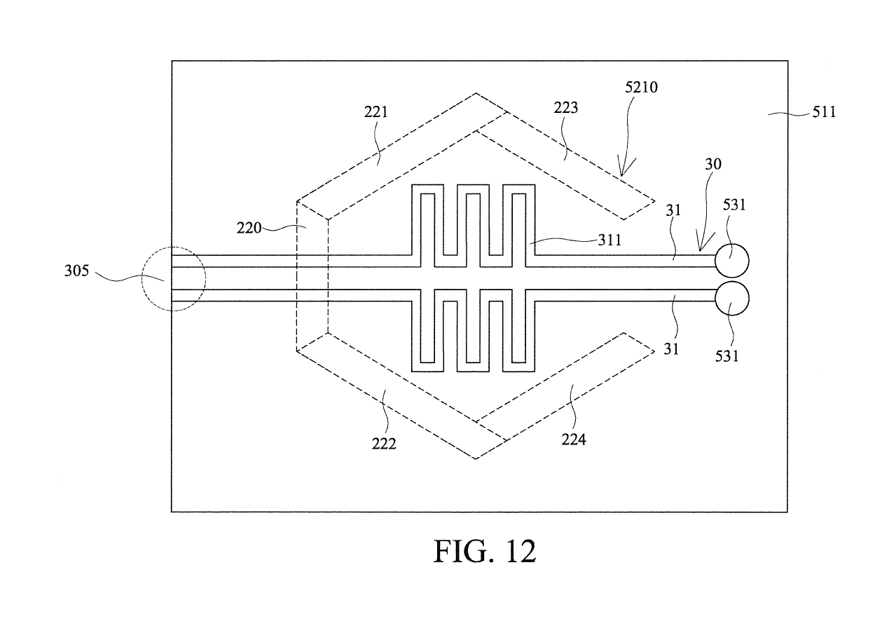

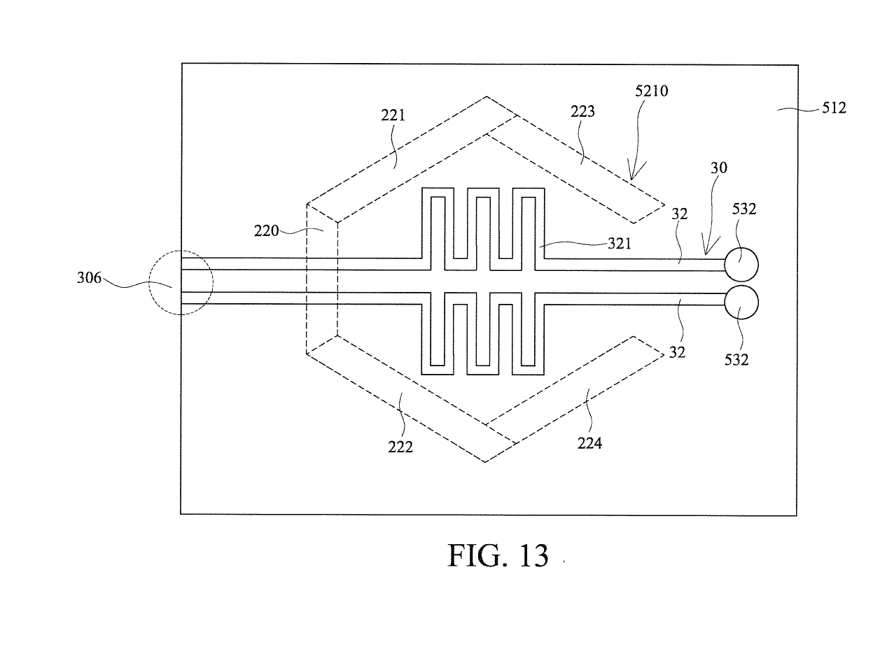

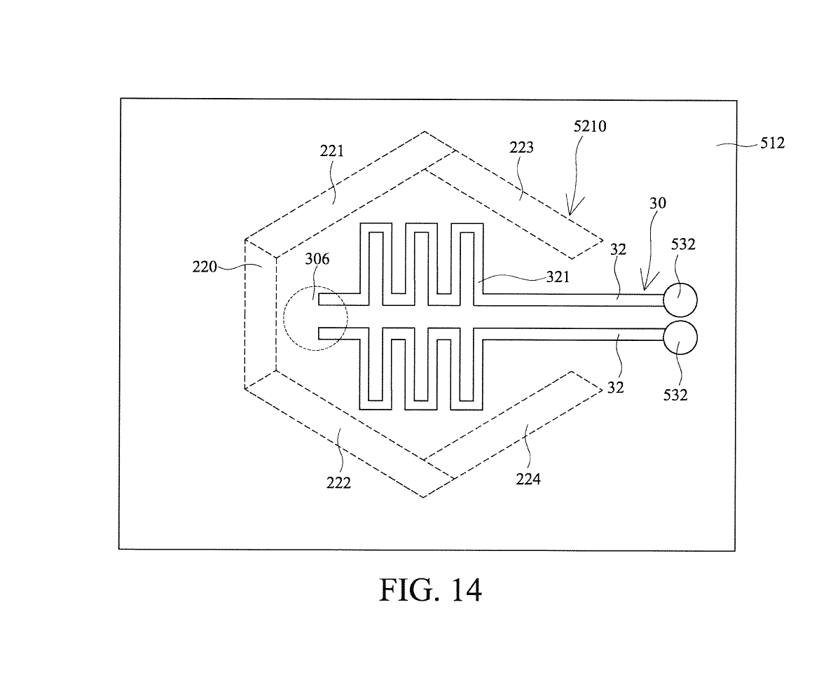

Again, referring to FIGS. 12 and 13, the two line segments 31, 32 of the pair of differential signal lines 30 in one embodiment of the present invention are allowed to surround the slotted ground structure 5210 above and below it, respectively. For instance, the two line segments 31, 32 are allowed to pass above and below the connection section 220 of the slotted ground structure 5210, respectively. Alternatively, in another embodiment, only one of the line segments (such as the first line segment 31, for example) of the pair of the differential signal lines 30 may be allowed to pass above or below the slotted ground structure 5210, as illustrated in FIG. 12, while the other one of the line segments (such as the second line segment 32, for example) may be never allowed to pass above or below the slotted ground structure 5210, as illustrated in FIG. 14.

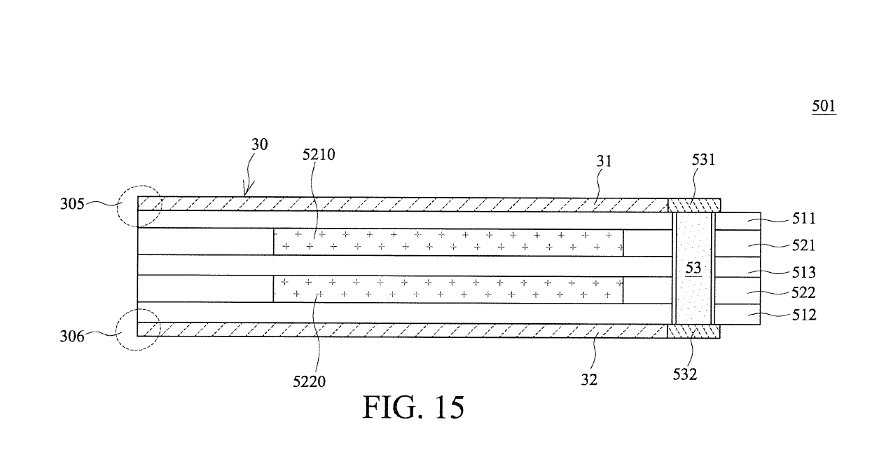

Referring to FIG. 15, there is shown a structural cross-sectional view of a filtering device with slotted ground structure according to another embodiment of the present invention. The filtering device 500 of the above embodiment is only provided with one slotted ground structure 5210; however, the filtering device 501 of the present embodiment may be further provided with two slotted ground structure 5210, 5220.

As illustrated in FIG. 15, there are additionally provided with a third substrate 513 and a second ground plane 522, in turn, between the first ground plane 521 and the second substrate 512. The second ground plane 522 is etched so as to form a second slotted ground structure 5220. The first line segment 31 may be electrically connected to the second line segment 32 via a first conductive via 53 passing through the first substrate 511, the first ground plane 521, the third substrate 513, the second ground plane 522 and the second substrate 512.

In one embodiment of the present invention, the shape of the etched second slotted ground structure 5220 is the same as that of the etched first slotted ground structure 5210. For instance, both of the first slotted ground structure 5210 and the second slotted ground structure 5220 are etched in the shape pattern of the slotted ground structure 203 shown in FIG. 6. Alternatively, the shape of the etched second slotted ground structure 5220 is different from that of the etched first slotted ground structure 5210. For instance, the first slotted ground structure 5210 is etched in the shape pattern of the slotted ground structure 203 shown in FIG. 6, while the second slotted ground structure 5220 is etched in the shape pattern of the slotted ground structure 200 shown in FIG. 3 instead. Moreover, aside from the shape pattern of the slotted ground structure 200/203, the shape pattern of one of the slotted ground structures 201/202/204/205/206 may be additionally selected for forming the first slotted ground structure 5210 and/or the second slotted ground structure 5210.

In the filtering device 501 of the present invention, the first line segment 31 is electromagnetically coupled to the first slotted ground structure 5210, while the second line segment 32 is electromagnetically coupled to the second slotted ground structure 5220.

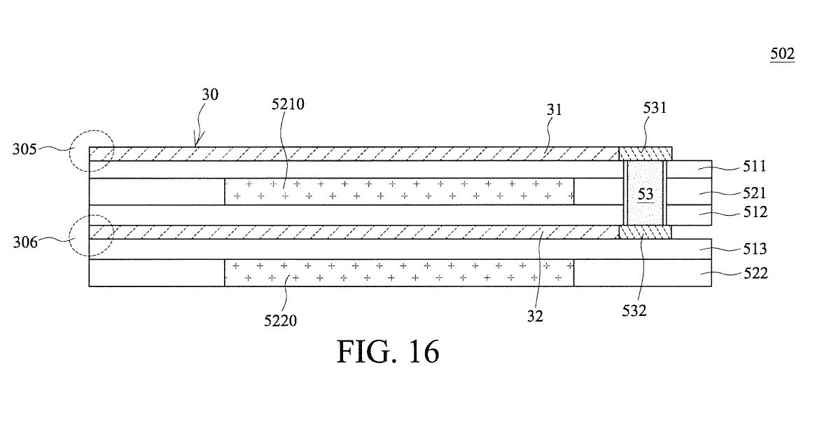

Referring to FIG. 16, there is shown a structural cross-sectional view of a filtering device with slotted ground structure according to another embodiment of the present invention. Compared with the filtering device 501 of the above embodiment, the filtering device 502 of the present invention is provided with the added third substrate 513 and the second ground plane 522, in turn, under the second line segment 32 of the pair of differential signal lines 30, instead of between the first ground plane 521 and the second substrate 512.

In the filtering device 502 of the present invention, the first line segment 31 is electromagnetically coupled to the first slotted ground structure 5210, while the second line segment 32 is electromagnetically coupled to the first slotted ground structure 5210 and/or the second slotted ground structure 5220, respectively.

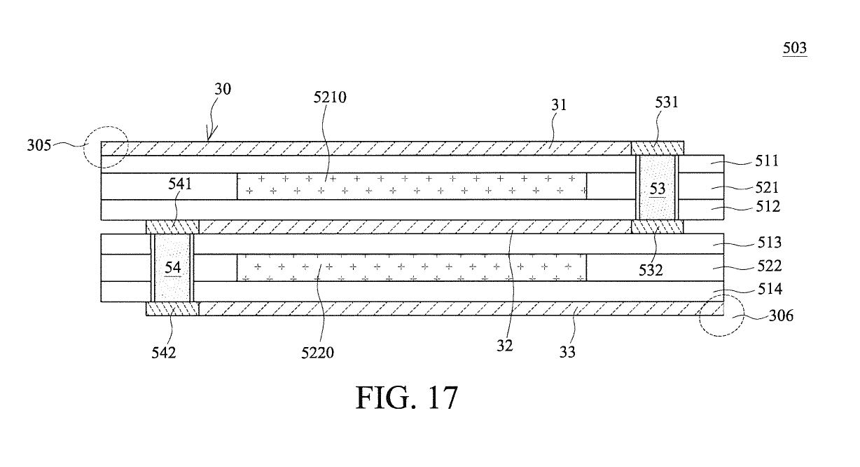

Referring to FIG. 17, there is shown a structural cross-sectional view of a filtering device with slotted ground structure according to another embodiment of the present invention. Subsequent to the structure of the filtering device 500 of previous embodiment, the filtering device 503 of the present invention further comprises a third substrate 513, a second ground plane 522, a fourth substrate 514 and a second conductive via 54, while the pair of differential signal lines 30 further comprise a third line segment 33.

The third substrate 513, the second ground plane 522 and the fourth substrate 514 are provided under the second line segment 32 of the differential signal lines 30 in turn. The third line segment 33 is horizontally provided on the bottom surface of the fourth substrate 514. The second conductive via 54 is vertically provided to pass through the third substrate 513, the second ground plane 522 and the fourth substrate 514. The second line segment 32 is connected to the second conductive via 54 via a third connection pad 541, while the third line segment 33 is connected to the second conductive via 54 via a fourth connection pad 542. Thus, the second line segment 32 is thus allowed to electrically connect to the third line segment 33 through the vertically disposed second conductive via 54. Then, when differential-mode signal is transmitted in the filtering device 502 in practice, differential-mode signal may be inputted from the signal input port 305, transmitted through the path consisting of the first line segment 31, the first conductive via 53, the second line segment 32, the second conductive via 54 and the third line segment 33, and then outputted from the signal output port 306. In addition, the second conductive via 54 and the second ground plane 522 are electrically isolated from each other.

In the filtering device 503 of the present invention, the first line segment 31 is electromagnetically coupled to the first slotted ground structure 5210, while the second line segment 32 is electromagnetically coupled to the first slotted ground structure 5210 and/or the second slotted ground structure 5220, respectively. Moreover, the third line segment 33 is electromagnetically coupled to the second slotted ground structure 5220.

In one embodiment of the present invention, the first conductive via 53 and/or the second conductive via 54 may be also allowed to pass through the slotted ground structure 5210, 5220 owing to the ease of provision or design consideration for electromagnetic coupling between the differential signal lines 30 and the slotted ground structures 5210, 5220.

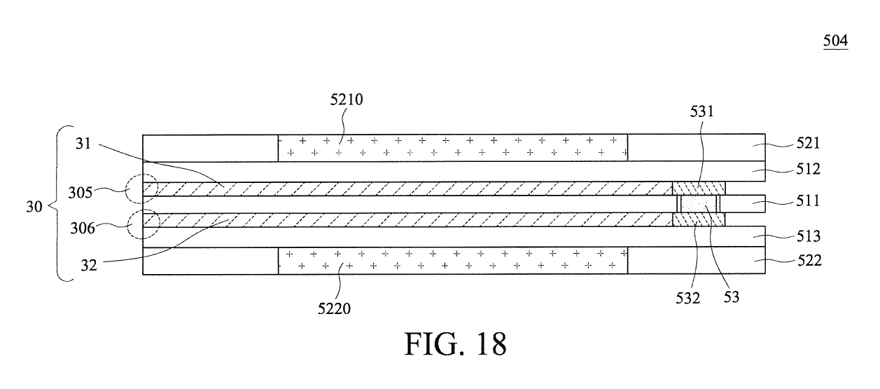

Referring to FIG. 18, there is shown a structural cross-sectional view of a filtering device with slotted ground structure according to another embodiment of the present invention. As illustrated in the figure, the filtering device 504 of the present embodiment comprises a pair of differential signal lines 30, a first substrate 511, a second substrate 512, a third substrate 513, a first ground plane 521 and a second ground plane 522.

In this case, each of two differential signal lines 30, symmetrically provided to each other, may comprise a first line segment 31 and a second line segment 32, respectively. The first line segment 31 is horizontally provided on the top surface of the first substrate 511, while the second line segment 32 is horizontally provided on the bottom surface of the first substrate 511. A first conductive via 53 is vertically provided to pass through the first substrate 511. The first line segment 31 is connected to the first conductive via 53 via a first connection pad 531, while the second line segment 32 is connected to the first conductive via 53 via a second connection pad 532. Then, the first line segment 31 is thus allowed to electrically connect to the second line segment 32 through the first conductive via 53.

Furthermore, the second substrate 512 is provided above the first line segment 31, and the first ground plane 521 having a first slotted ground structure 5210 is provided on the top surface of the second substrate 512. Moreover, the third substrate 513 is provided under the second line segment 32, and the second ground plane 522 having a second slotted ground structure 5220 is provided on the bottom surface of third substrate 513. In this case, in the filtering device 504 of the present invention, the first line segment 31 is electromagnetically coupled to the first slotted ground structure 5210, while the second line segment 32 is electromagnetically coupled to the second slotted ground structure 5220. Furthermore, in the filtering device 504 of the present invention, an identical etched shape or different etched shapes may be provided for the first slotted ground structure 5210 and the second slotted ground structure 5220, respectively.

In each of above embodiments of the present invention, the first ground plane 521 and the second ground plane 522 may be electrically connected to each other by means of an external connecting circuit or a conductive via.

When the filtering device 100/500/501/502/503/504 of the present invention is used in an electronic product in practice, the filtering device is drillingly provided with connecting circuits required for other application circuits owing to the consideration for the volume of electronic product or the ease for layout of other application circuits. In this connection, it is also understood by those skilled in the art that even the filtering device 100/500/501/502/503/504 of the present invention is additionally provided with several electrically conductive vias required for other application circuits, it still should be included in the scope of Claim of the present invention.

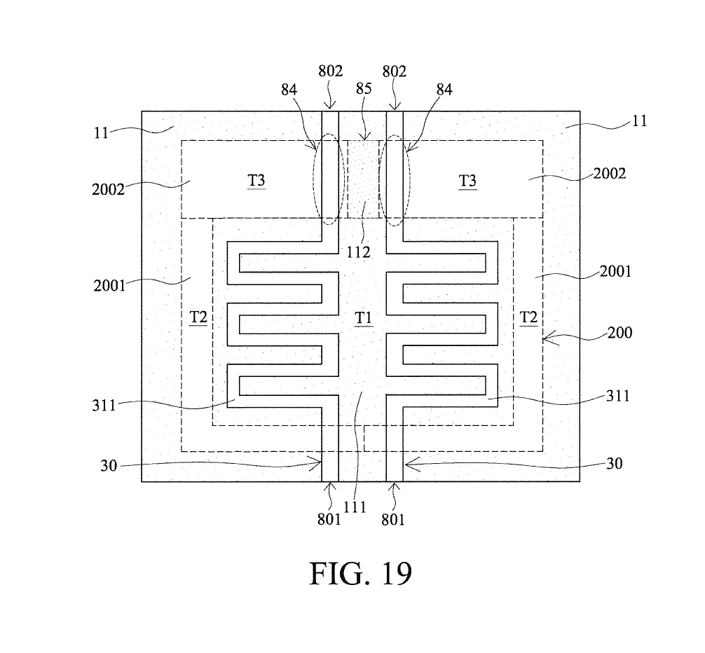

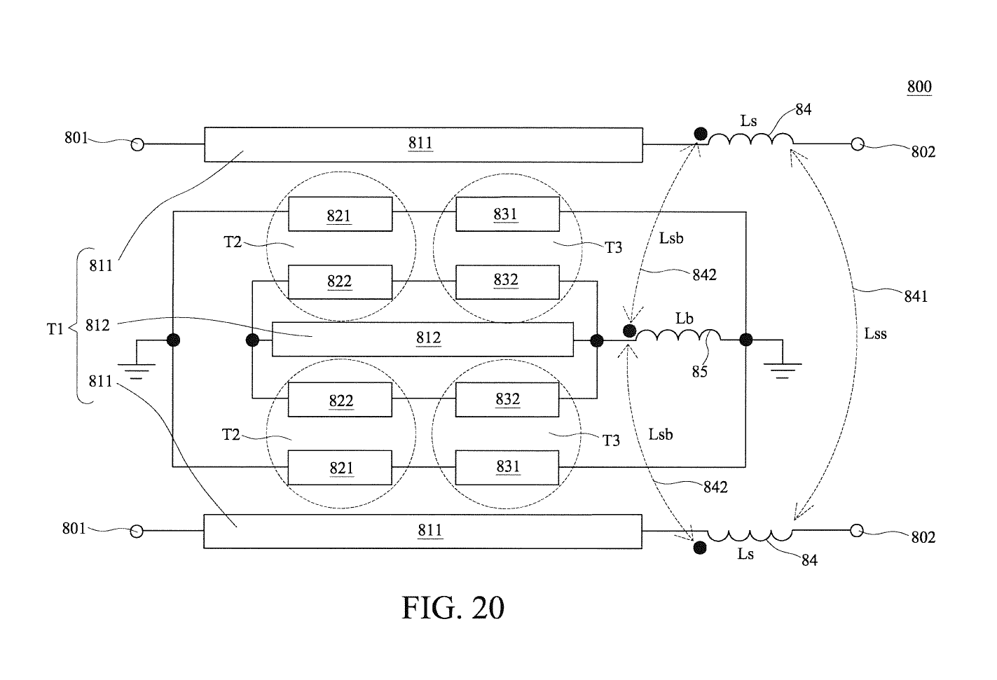

Referring to, in combination with FIG. 3, FIGS. 19 and 20, there are shown a structural perspective top view of a filtering device with slotted ground structure according to another embodiment of the present invention and a diagram of circuit structure of equivalent circuit of the filtering device according to one preferred embodiment of the filtering device, respectively. As mentioned above, the filtering device 100 is provided with a pair of differential signal lines 30 on the top surface of a substrate 10, and a ground plane 11 on the bottom surface thereof.

As illustrated in FIG. 19, the ground plane 11 is etched to form a C-shaped of slotted ground structure 200. The slotted ground structure 200 comprises a metal pad 111 and a connection portion 112, two first slotted regions 2001 and two second slotted regions 2002. The two first slotted regions 2001 are regions consisting of the connection section 210, the first section 211 and the second section 212 illustrated in FIG. 3, while the two second slotted regions 2002 are equivalent to the third section 213 and the fourth section 214 illustrated in FIG. 3, respectively. The two first slotted regions 2001 and the two second slotted regions 2002 are allowed to surround the periphery of the metal pad 111, and the metal pad 111 is connected to the ground plane 11 outside through the connection portion 112. In addition, the pair of differential signal lines 30 of the present embodiment may be also designed to comprise a pair of meandering parts 311 corresponded to each other, the meandering parts 311 being provided above the metal pad 111 projectively.

Referring to FIG. 20, the equivalent circuit 800 comprises a first equivalent transmission line model (T₁), two second equivalent transmission line model (T₂) and two third equivalent transmission line model (T₃). The meandering parts 311 of the pair of differential signal lines 30 are electromagnetically coupled to the metal pad 111 so as to generate the first equivalent transmission line model (T₁). In this case, the first equivalent transmission line model (T₁) is served as the equivalent transmission line model for the structure of differential signal lines. The metal pad 111 is electromagnetically coupled to the ground plane 11 distributed beside the two first slotted regions 2001, respectively, so as to generate the two second equivalent transmission line model (T₂), while the metal pad 111 is electromagnetically coupled to the ground plane 11 distributed beside the two second slotted regions 2002, respectively, so as to generate the two third equivalent transmission line model (T₃). In this case, each of the second equivalent transmission line model (T₂) and the third equivalent transmission line model (T₃) may be served as the equivalent transmission line model for the slotted ground structure.

The first equivalent transmission line model (T₁) comprises two first main transmission lines 811 and a first sub-transmission line 812, the two first main transmission lines 811 indicating the equivalent element of the two meandering parts 311, while the first sub-transmission line 812 indicating the equivalent element of the metal pad 111. The second equivalent transmission line model (T₂) comprises a second main transmission line 821 and a second sub-transmission line 822, the second main transmission line 821 indicating the equivalent element of the ground plane 11, while the second sub-transmission line 822 indicating the equivalent element of the metal pad 111. The third equivalent transmission line model (T₃) comprises a third main transmission line 831 and a third sub-transmission line 832, the third main transmission line 831 indicating the equivalent element of the ground plane 11, while the third sub-transmission line 832 indicating the equivalent element of the metal pad 111.

In the first equivalent transmission line model (T₁), one port of each first main transmission line 811 is connected to a signal input port 801, respectively, while the other port is connected to a signal output port 802 through a first inductance (Lₛ) 84, respectively. Each first inductance (Lₛ) 84 is used to indicate the equivalent element of parts of line segment of the pair of differential signal lines 30 projected onto each second slotted region 2002. The first sub-transmission line 812 is grounded through the connection to a second inductance (L_{b}) 85, the second inductance (L_{b}) 85 indicating the equivalent element of the connection portion 112.

In each second equivalent transmission line model (T₂) and each third equivalent transmission line model (T₃), one port of the second main transmission line 821 is grounded directly, while the other port of the second main transmission line 821 is grounded through serial connection to the corresponding third main transmission line 831. One port of the second sub-transmission line 822 is connected to one port of the first sub-transmission line 812, while the other port of the second sub-transmission line 822 is connected to the other port of first sub-transmission line 812 through serial connection to the corresponding third sub-transmission line 832. Then, each second sub-transmission line 822 together with the corresponding serially connected third sub-transmission line 832 may be connected to the first sub-transmission line 812 in parallel.

Furthermore, in one embodiment of the present invention, a first mutual inductance (Lₛₛ) 841 is generated between the two first inductances (Lₛ) 84, and a second mutual inductance (L_{sb}) 842 is generated between each first inductance (Lₛ) 84 and the second inductance (L_{b}) 85.

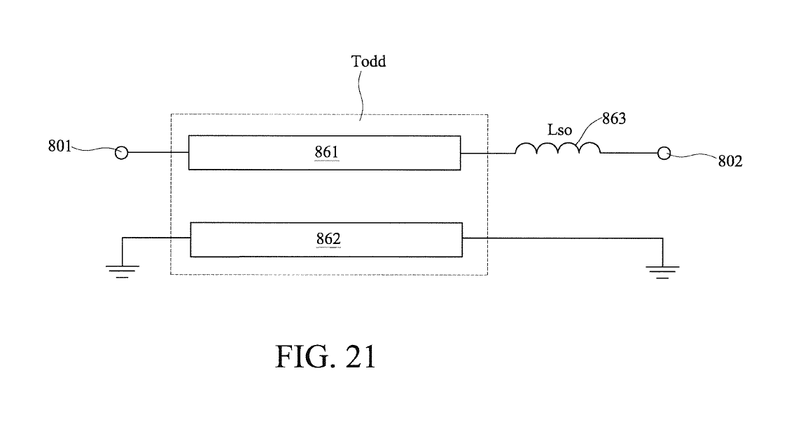

Referring to FIG. 21, there is shown a diagram of circuit structure of an odd-mode equivalent circuit of the equivalent circuit illustrated in FIG. 20 of the present invention. As illustrated in the figure, the odd-mode equivalent circuit which, is an equivalent half circuit in odd mode of the equivalent circuit 800 shown in FIG. 20, comprises an odd-mode equivalent transmission line model (T_{odd}).

The odd-mode equivalent transmission line model (T_{odd}) comprises a fourth equivalent transmission line model 861 and a fourth sub-transmission line 862. One port of the fourth main transmission line 861 is connected to the signal input port 801, while the other port of the fourth main transmission line 861 is connected to the signal output port 802 through a third inductance (Lₛₒ) 863. Two ports of the fourth sub-transmission line 862 on both right and left sides thereof are grounded directly.

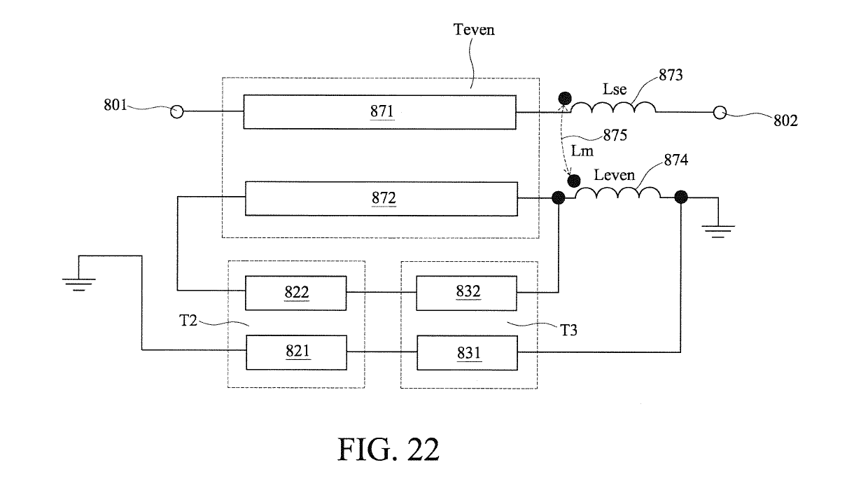

Referring to FIG. 22, there is shown a diagram of circuit structure of an even-mode equivalent circuit of the equivalent circuit illustrated in FIG. 20 of the present invention. As illustrated in the figure, the even-mode equivalent circuit which, is an equivalent half circuit in even mode of the equivalent circuit 800 shown in FIG. 20, comprises an even-mode equivalent transmission line model (Tₑᵥₑₙ), a second equivalent transmission line model (T₂) and a third equivalent transmission line model (T₃).

The even-mode equivalent transmission line model (Tₑᵥₑₙ) comprises a fifth main transmission line 871 and a fifth sub-transmission line 872. One port of the fifth main transmission line 871 is connected to the signal input port 801, while the other port of the fifth main transmission line 871 is connected to the signal output port 802 through a fourth inductance (Lₛₑ) 873. The fifth sub-transmission line 872 is grounded through a fifth inductance (Lₑᵥₑₙ) 874. One port of the second main transmission line 821 in the second equivalent transmission line model (T₂) is grounded directly, while the other port of the second main transmission line 821 in the second equivalent transmission line model (T₂) is grounded through the connection to the third main transmission line 831 in the third equivalent transmission line model (T₃). One port of the second sub-transmission line 822 in the second equivalent transmission line model (T₂) is connected to one port of the fifth sub-transmission line 872, while the other port of the second sub-transmission line 822 in the second equivalent transmission line model (T₂) is connected to the other port of the fifth sub-transmission line 872 through serial connection to the third sub-transmission line 832. As such, the second sub-transmission line 822 and together with the corresponding serially connected third sub-transmission line 832 may be connected to the fifth sub-transmission line 872 in parallel.

Furthermore, in another embodiment of the present invention, a third mutual inductance (Lₘ) 875 is generated between the fourth inductance (Lₛₑ) 873 and the fifth inductance (Lₑᵥₑₙ) 874.

In this case, the relation of transmission characteristic between the odd-mode equivalent transmission line model (T_{odd}) together with the even-mode equivalent transmission line model (Tₑᵥₑₙ) and the first equivalent transmission line model (T₁) is written as:

T_{1(Z}_{₁})={square root over (T_{odd(Z}_{_{odd}}₎T_{even(Z}_{ₑᵥₑₙ₎})} (1)

In this case, Z₁ is the characteristic impedance of the first equivalent transmission line model (T₁), Z_{odd} is the characteristic impedance of the odd-mode equivalent transmission line model (T_{odd}) and Zₑᵥₑₙ is the characteristic impedance of the even-mode equivalent transmission line model (Tₑᵥₑₙ).

Moreover, the corresponding relationships among the inductive elements 84, 85, 841, 842, 863, 873, 874 and 875 are written as follows:

Lₛₒ=Lₛ−Lₛₛ (2)

Lₛₑ=Lₛ+Lₛₛ−L_{sb} (3)

Lₑᵥₑₙ=2L_{b}−L_{sb} (4)

Lₘ=L_{sb} (5)

Thus, the odd-mode equivalent circuit illustrated in FIG. 21 may be provided for differential-mode signal with transmission characteristic of reduced decay and low loss, without effect on the transmission of differential-mode signal. The even-mode equivalent circuit illustrated in FIG. 22 may be provided for common-mode noise with frequency response occurred at a first specific frequency, so as to form a low impedance path for the common-mode noise, thus guiding the common-mode noise to the ground potential to form a first zero at the first specific frequency. Alternatively, the frequency response may be occurred at a second specific frequency so as to form a high impedance path for the common-mode noise, in such a way that the common-mode noise may be guided back to an original route without being transmitted continuously, thus forming a second zero at the second specific frequency. In this connection, the equivalent circuit illustrated in FIG. 20 may be allowed to not only suppress the common-mode noise, but also maintain the differential-mode signal to be transmitted without being effected. Moreover, it also should be understood by those skilled in this art that the first specific frequency and the second specific frequency may be situated at either the same frequency or different frequencies.

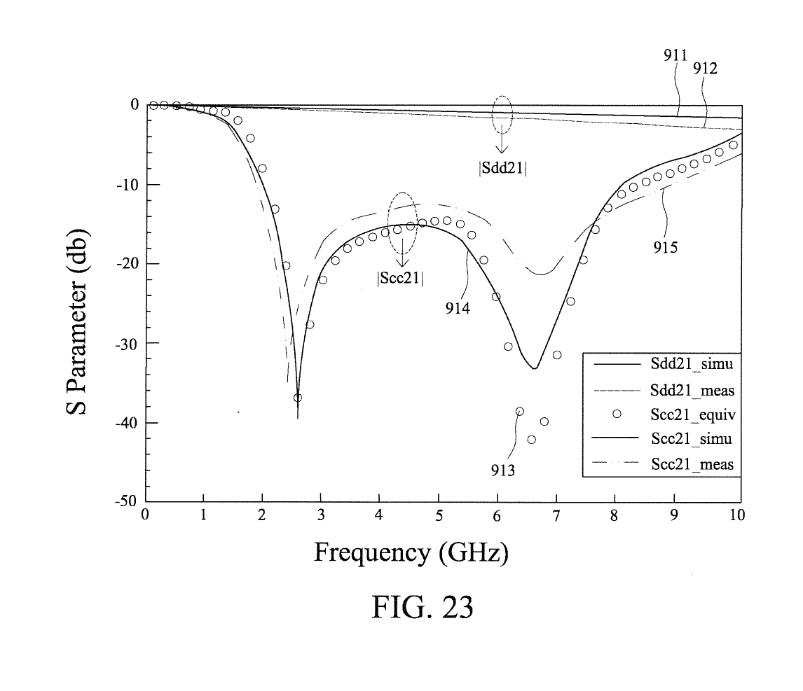

Referring to FIG. 23, there is shown an oscillogram obtained by differential-mode and common-mode full-wave simulation and measurement with respect to a filtering device with slotted ground structure of the present invention and equivalent circuit thereof. As illustrated in the figure, a differential-mode insertion loss curve (Sdd21_meas) 912 and a common-mode insertion loss curve (Scc21_meas) 915 are obtained by the measurement of the differential-mode signal and the common-mode noise, respectively, in practical application of the filtering device 100. A differential-mode insertion loss curve (Sdd21_simu) 911 and a common-mode insertion loss curve (Scc21_simu) 914 are obtained by the full-wave simulation of the differential-mode signal and the common-mode noise, respectively, with respect to the filtering device 100. Moreover, a common-mode insertion loss curve (Scc21_equiv) 913 may be obtained by the simulation with respect to the equivalent whole circuit 800.

In the case of common-mode noise, it is generally to use −10 dB as the basis for insertion loss |Scc21| of the common-mode noise, an insertion loss |Scc21| below −10 dB indicating an effectively suppressed common-mode noise. Taking the present invention as an example, insertion loss |Scc21| on the curve (Scc21_equiv) 913 within the frequency band between 2.3 GHz and 8.2 GHz, insertion loss |Scc21| on the curve (Scc21_simu) 914 within the frequency band between 2.2 GHz and 8.0 GHz, and insertion loss IScc21 on the curve (Scc21_meas) 915 within the frequency band between 1.9 GHz and 8.9 GHz are all situated below −10 dB. As known from the three common-mode insertion loss curves 913, 914, 915, the filtering device 100 or equivalent circuit 800 proposed in the present invention may be used for suppressing the common mode noise within an extremely wide frequency range so as to avoid the common mode noise to interfere the differential mode signal transmitted on the differential signal lines 30.

Furthermore, in the case of the differential-mode signal, either on the curve (Sdd21_meas) 911 of simulation result or on the curve (Sdd21_meas) 912 of measurement result obtained in practical use, differential-mode signal may approach 0 dB, with insertion loss Sdd21 being always lower than −3 dB when differential-mode signal is transmitted in any frequency range. Therefore, when one slotted ground structure 200 used for suppressing the common-mode noise is built in the filtering device 100 of the present invention, signal decay may be not occurred significantly in transmission of differential-mode signal, thus maintaining a better quality of transmission.

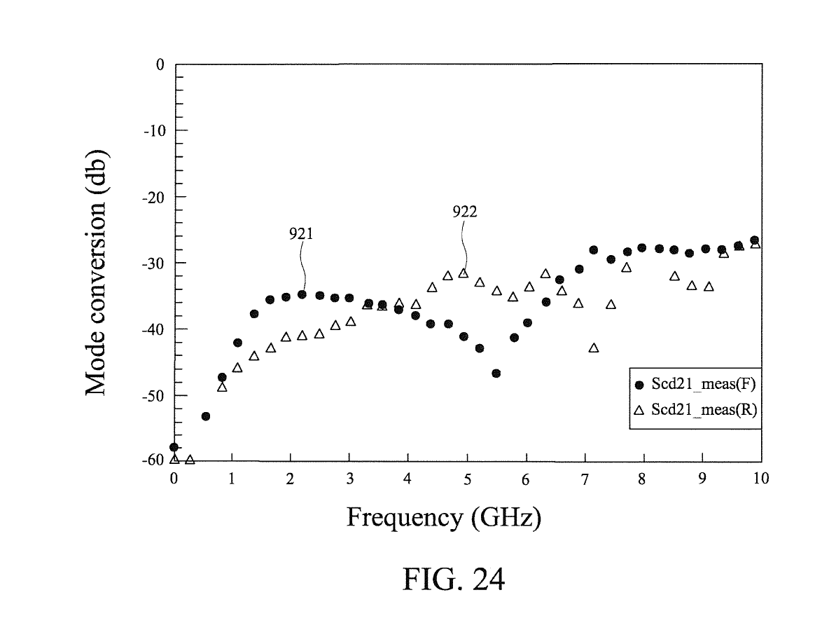

Referring to FIG. 24, there is shown an oscillogram illustrating the mode conversion with respect to a filtering device with slotted ground structure of the present invention. As illustrated in the figure, a model conversion curve (Scd_{—}21_meas (F)) 921 may be obtained by a model conversion procedure that is performed in the filtering device 100 provided with the slotted ground structure 200 of the present invention, while the other model conversion curve (Scd21_meas (R)) 922 may be obtained by the model conversion procedure that is performed in a reference device (such as, consisting of a substrate 10, a ground plane 11 without being etched to form slotted ground structure and a pair of differential signal lines 30, for example) without slotted ground structure 200.

On the model conversion curve (Scd_meas (F)) 921 obtained by the model conversion procedure that is performed in the filtering device 100 of the present invention, the insertion loss |Scd21| is situated below −25 dB, also without significant increment compared with the model conversion curve (Scd21_meas (R)) 922 obtained by the model conversion procedure that is performed in the reference device.

It can be seen, thus, the structure of differential transmission line, in the filtering device 100 of the present invention, established by the use of slotted ground structure 200 is provided with a better structural symmetry, in such a way that either signal decay of the differential-mode signal resulted from the conversion of parts of the differential-mode signal into common-mode noise, or interference the transmission of the differential-mode signal resulted from the conversion of parts of the common-mode noise into the differential-mode signal may be avoided.

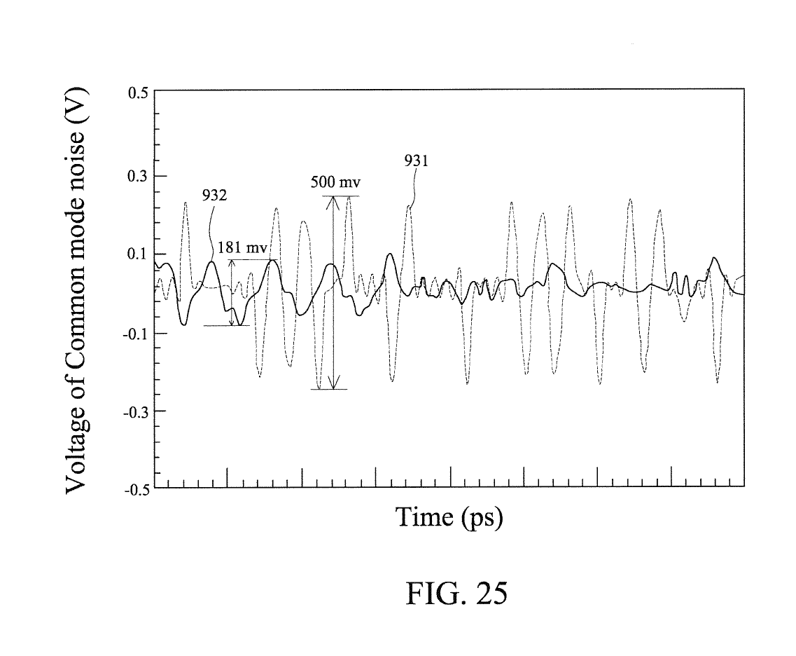

Referring to FIG. 25, there is shown an oscillogram illustrating output voltage of common-mode noise of a filtering device of the present invention. As illustrated in the figure, the peak-to-peak amplitude of output voltage on a voltage curve 931 of common-mode noise for the reference device is 500 mV. Correspondingly, the peak-to-peak amplitude of output voltage on a voltage curve 932 of common-mode noise for the filtering device 100 of the present invention is only 181 mV.

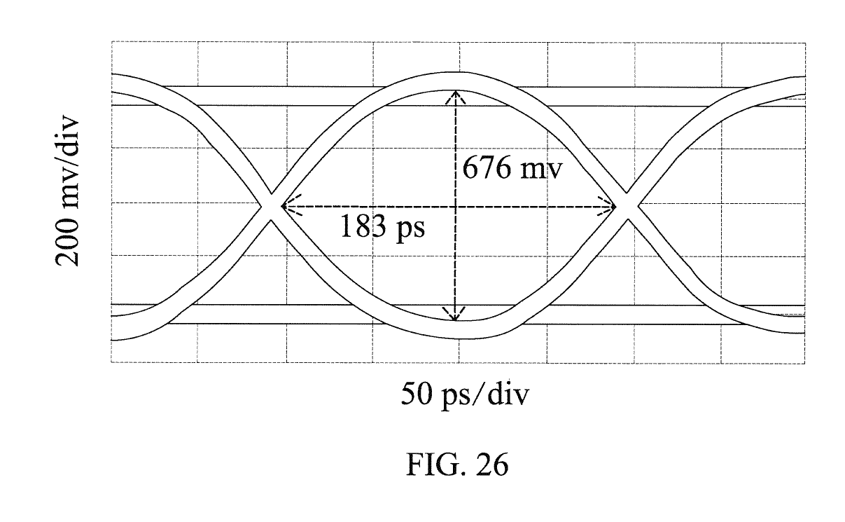

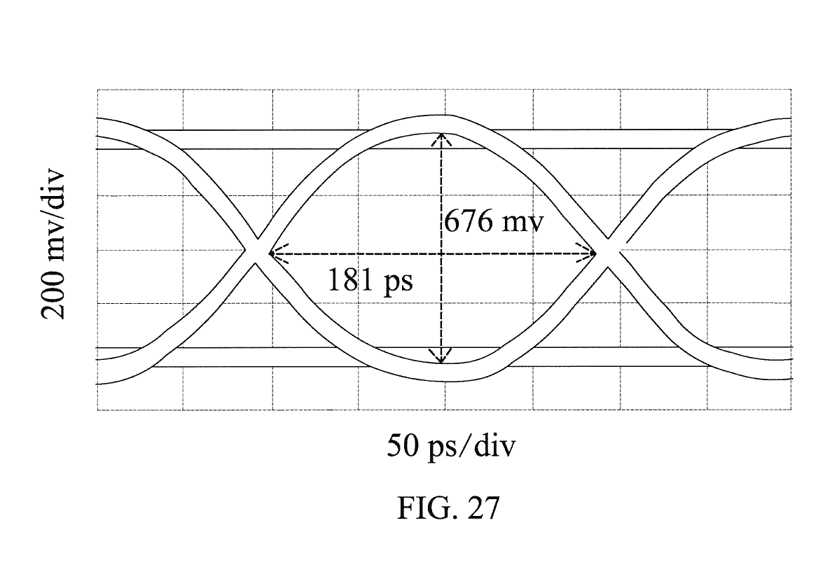

Referring to FIGS. 26 and 27, there are shown eye diagrams of measurements on differential-mode signals of a reference device and a filtering device of the present invention, respectively. As illustrated in FIG. 26, the eye height and eye width in the eye diagram of differential-mode signal of the reference device are 676 mV and 183 ps, respectively. As illustrated in FIG. 27, correspondingly, the eye height and eye width of the filtering device 100 of the present invention are 676 mV and 181 ps, respectively. In these two eye diagrams of devices, the degree of one opening is almost similar to that of the other. It is then proven that the original quality of transmission is never affected when this slotted ground structure 200 is additionally provided in the filtering device 100.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

1. A filtering device with slotted ground structure, used for suppressing common-mode noise generated when differential-mode signal is transmitted, comprising:
a first substrate;
a second substrate;
a first ground plane, provided between said first substrate and said second substrate, comprising a first slotted ground structure; and
a pair of differential signal lines, each of said two differential signal lines being provided symmetrically to each other, comprising a first line segment and a second line segment, respectively, said first line segment being horizontally provided on the top surface of said first substrate, said second line segment being horizontally provided on the bottom surface of said second substrate;
wherein said first line segment is electrically connected to said second line segment through a vertically disposed first conductive via, said first conductive via passing through said first substrate, said first ground plane and said second substrate.

2. The filtering device according to claim 1, wherein said first slotted ground structure comprises a first section and a second section, a third section, a fourth section and a connection section, said connection section being extended perpendicularly to and across said pair of differential signal lines projectively, said first section and said second section being interconnected, on one side edge thereof, through said connection section, as well as being connected, on the other side edge thereof, to said third section and said fourth section, respectively, said third section and said fourth section facing each other, with a clearance therebetween, toward a center line between said pair of differential signal lines, wherein said first section and said second section are of the same size, while said third section and said fourth section are of the same size, said first section and said connection section being interconnected to form a first included angle, said second section and said connection section being interconnected to form a second included angle, said third section and said first section being interconnected to form a third included angle, said fourth section and said second section being interconnected to form a fourth included angle, said first included angle being equal to said second included angle, said third included angle being equal to said fourth included angle.

3. The filtering device according to claim 1, wherein said first slotted ground structure comprises a first section, a second section and a connection section, said connection section being extended perpendicularly to and across said pair of differential signal lines projectively, said first section and said second section being interconnected, on one side edge thereof, through said connection section, wherein said first section and said second section are of the same size, said first section and said connection section being interconnected to form a first included angle, said second section and said connection section being interconnected to form a second included angle, said first included angle and said second included angle being equal and presented as a non-right angle.

4. The filtering device according to claim 1, wherein a third substrate and a second ground plane are further provided between said first ground plane and said second substrate, said second ground plane comprising a second slotted ground structure, said first conductive via further passing through said third substrate and said second ground plane, in such as way that said second line segment is electrically connected to said first line segment through said first conductive via passing through said first substrate, said first ground plane, said third substrate, said second ground plane and said second substrate.

5. The filtering device according to claim 4, wherein said second slotted ground structure comprises a first section and a second section, a third section, a fourth section and a connection section, said connection section being extended perpendicularly to and across said pair of differential signal lines projectively, said first section and said second section being interconnected, on one side edge thereof, through said connection section, as well as being connected, on the other side edge thereof, to said third section and said fourth section, respectively, said third section and said fourth section facing each other, with a clearance therebetween, toward a center line between said pair of differential signal lines, wherein said first section and said second section are of the same size, while said third section and said fourth section are of the same size, said first section and said connection section being interconnected to form a first included angle, said second section and said connection section being interconnected to form a second included angle, said third section and said first section being interconnected to form a third included angle, said fourth section and said second section being interconnected to form a fourth included angle, said first included angle being equal to said second included angle, said third included angle being equal to said fourth included angle.

6. The filtering device according to claim 4, wherein said second slotted ground structure comprises a first section, a second section and a connection section, said connection section being extended perpendicularly to and across said pair of differential signal lines projectively, said first section and said second section being interconnected, on one side edge thereof, through said connection section, wherein said first section and said second section are of the same size, said first section and said connection section being interconnected to form a first included angle, said second section and said connection section being interconnected to form a second included angle, said first included angle and said second included angle being equal and presented as a non-right angle.

7. The filtering device according to claim 4, wherein an etching process is carried out on said first ground plane and said second ground plane to form said first slotted ground structure and said second slotted ground structure, in which said first slotted ground structure and said second slotted ground structure are presented as an identical etched shape or different etched shapes.

8. The filtering device according to claim 1, wherein said pair of first line segments and/or said pair of second line segments of said pair of differential signal lines are provided with a pair of meandering parts symmetric to each other, respectively.

9. The filtering device according to claim 1, wherein a third substrate and a second ground plane are further provided under said second line segments of said pair of differential signal lines, said second ground plane comprising a second slotted ground structure.

10. The filtering device according to claim 9, wherein said second slotted ground structure comprises a first section and a second section, a third section, a fourth section and a connection section, said connection section being extended perpendicularly to and across said pair of differential signal lines projectively, said first section and said second section being interconnected, on one side edge thereof, through said connection section, as well as being connected, on the other side edge thereof, to said third section and said fourth section, respectively, said third section and said fourth section facing each other, with a clearance therebetween, toward a center line between said pair of differential signal lines, wherein said first section and said second section are of the same size, while said third section and said fourth section are of the same size, said first section and said connection section being interconnected to form a first included angle, said second section and said connection section being interconnected to form a second included angle, said third section and said first section being interconnected to form a third included angle, said fourth section and said second section being interconnected to form a fourth included angle, said first included angle being equal to said second included angle, said third included angle being equal to said fourth included angle.

11. The filtering device according to claim 9, wherein said second slotted ground structure comprises a first section, a second section and a connection section, said connection section being extended perpendicularly to and across said pair of differential signal lines projectively, said first section and said second section being interconnected, on one side edge thereof, through said connection section, wherein said first section and said second section are of the same size, said first section and said connection section being interconnected to form a first included angle, said second section and said connection section being interconnected to form a second included angle, said first included angle and said second included angle being equal and presented as a non-right angle.

12. The filtering device according to claim 9, wherein an etching process is carried out on said first ground plane and said second ground plane to form said first slotted ground structure and said second slotted ground structure, in which said first slotted ground structure and said second slotted ground structure are presented as an identical etched shape or different etched shapes.

13. The filtering device according to claim 1, wherein a third substrate, a second ground plane and a fourth substrate are further provided under said second line segments of said pair of differential signal lines, said second ground plane comprising a second slotted ground structure, furthermore, said pair of differential signal lines further comprising a third line segment horizontally provided on the bottom surface of said fourth substrate, said second line segment being electrically connected to said third line segment through a second conductive via passing through said third substrate, said second ground plane and said fourth substrate.

14. The filtering device according to claim 13, wherein said second slotted ground structure comprises a first section and a second section, a third section, a fourth section and a connection section, said connection section being extended perpendicularly to and across said pair of differential signal lines projectively, said first section and said second section being interconnected, on one side edge thereof, through said connection section, as well as being connected, on the other side edge thereof, to said third section and said fourth section, respectively, said third section and said fourth section facing each other, with a clearance therebetween, toward a center line between said pair of differential signal lines, wherein said first section and said second section are of the same size, while said third section and said fourth section are of the same size, said first section and said connection section being interconnected to form a first included angle, said second section and said connection section being interconnected to form a second included angle, said third section and said first section being interconnected to form a third included angle, said fourth section and said second section being interconnected to form a fourth included angle, said first included angle being equal to said second included angle, said third included angle being equal to said fourth included angle.

15. The filtering device according to claim 13, wherein said second slotted ground structure comprises a first section, a second section and a connection section, said connection section being extended perpendicularly to and across said pair of differential signal lines projectively, said first section and said second section being interconnected, on one side edge thereof, through said connection section, wherein said first section and said second section are of the same size, said first section and said connection section being interconnected to form a first included angle, said second section and said connection section being interconnected to form a second included angle, said first included angle and said second included angle being equal and presented as a non-right angle.

16. The filtering device according to claim 13, wherein an etching process is carried out on said first ground plane and said second ground plane to form said first slotted ground structure and said second slotted ground structure, in which said first slotted ground structure and said second slotted ground structure are presented as an identical etched shape or different etched shapes.

17. The filtering device according to claim 13, wherein said pair of first line segments, said pair of second line segments and/or said pair of third line segments of said pair of differential signal lines are provided with a pair of meandering parts symmetric to each other, respectively.

18. A filtering device with slotted ground structure, used for suppressing common-mode noise generated when differential-mode signal is transmitted, comprising:
a first substrate;
a pair of differential signal lines, each of said two differential signal lines being provided symmetrically to each other, comprising a first line segment and a second line segment, respectively, said first line segment being horizontally provided on the top surface of said first substrate, said second line segment being horizontally provided on the bottom surface of said first substrate, said first line segment being electrically connected to said second line segment through a vertically disposed first conductive via, said first conductive via passing through said first substrate;
a second substrate, provided above said first line segment;
a third substrate, provided under said second line segment;
a first ground plane, provided on the top surface of said second substrate, comprising a first slotted ground structure; and
a second ground plane, provided on the bottom surface of said third substrate, comprising a second slotted ground structure.

19. The filtering device according to claim 18, wherein said first slotted ground structure or said second slotted ground structure comprises a first section and a second section, a third section, a fourth section and a connection section, said connection section being extended perpendicularly to and across said pair of differential signal lines projectively, said first section and said second section being interconnected, on one side edge thereof, through said connection section, as well as being connected, on the other side edge thereof, to said third section and said fourth section, respectively, said third section and said fourth section facing each other, with a clearance therebetween, toward a center line between said pair of differential signal lines, wherein said first section and said second section are of the same size, while said third section and said fourth section are of the same size, said first section and said connection section being interconnected to form a first included angle, said second section and said connection section being interconnected to form a second included angle, said third section and said first section being interconnected to form a third included angle, said fourth section and said second section being interconnected to form a fourth included angle, said first included angle being equal to said second included angle, said third included angle being equal to said fourth included angle.

20. The filtering device according to claim 18, wherein said first slotted ground structure or said second slotted ground structure comprises a first section, a second section and a connection section, said connection section being extended perpendicularly to and across said pair of differential signal lines projectively, said first section and said second section being interconnected, on one side edge thereof, through said connection section, wherein said first section and said second section are of the same size, said first section and said connection section being interconnected to form a first included angle, said second section and said connection section being interconnected to form a second included angle, said first included angle and said second included angle being equal and presented as a non-right angle.

21. The filtering device according to claim 18, wherein an etching process is carried out on said first ground plane and said second ground plane to form said first slotted ground structure and said second slotted ground structure, in which said first slotted ground structure and said second slotted ground structure are presented as an identical etched shape or different etched shapes.

22. The filtering device according to claim 18, wherein said pair of first line segments and/or said pair of second line segments of said pair of differential signal lines are provided with a pair of meandering parts symmetric to each other, respectively.
